(19) United States
(12) Patent Application Publication
(10) Pub. No.: US 2026/0354613 A1
(43) Pub. Date: Nov. 12, 2026

(54) LIQUID HEATING APPLIANCES

(71) Applicant: Strix (China) Limited, Guangzhou (CN)

(72) Inventors: Colin Moughton, Port St. Mary (GB); Richard Fumagalli, Chester (GB); Raymond Doyle, Douglas (GB)

(21) Appl. No.: 19/475,307

(22) PCT Filed: Apr. 12, 2024
(86) PCT No.: PCT/GB2024/050962

§ 371 Date: Oct. 14, 2025

(30) Foreign Application Priority Data
Apr. 13, 2023 (GB) 2305450.5
May 12, 2023 (CN) 202310542833.X

(51) Int. Cl. A47J 27/21; H05B 1/02

(52) U.S. Cl. CPC A47J 27/2105; A47J 27/21166; H05B 1/0269

(57) ABSTRACT

A liquid heating appliance comprising a liquid heating vessel comprising a cordless electrical adaptor (14) and a cordless power base comprising a cordless electrical connector (16). A vertical force (62, 72) applied by at least one resiliently biased vertically acting member (38, 58), provided in the connector (16) and/or adaptor (14), and a horizontal force (64, 66) applied by the at least one horizontally acting member (50, 52), provided in the connector (16) and/or adaptor (14), are pre-set such that when the liquid heating vessel is seated on the cordless power base: the vertical force (62, 72) is unable to overcome: the weight (74) of the liquid heating vessel, empty of any liquid, and a frictional force (68, 70) generated by the horizontal force (64, 66); such that the adaptor (14) does not separate from the connector (16); and when the liquid heating vessel is lifted away from the cordless power base: the vertical force combined with a weight of the cordless power base overcomes the frictional force such that the connector (16) freely separates from the adaptor (14).

The present invention relates to liquid heating appliances, in particular liquid heating appliances comprising a liquid heating vessel which can be seated on a cordless power base.

Liquid heating appliances are known to comprise a liquid heating vessel which can be seated on a cordless power base so as to provide the liquid heating vessel with electrical power. The liquid heating vessel typically comprises a cordless adaptor and the cordless power base typically comprises a cordless connector. When coupled together, the cordless connector and cordless adaptor facilitate the transmission of electrical power to the liquid heating vessel, e.g. to a heating element thereof. Cordless connectors and adaptors in the prior art typically each comprise a plurality of electrical contacts, e.g. live, neutral and earth contacts. In order to ensure the electrical contacts properly contact one another when the connector and adaptor are coupled together, in any given pair of electrical contacts, at least one contact in the pair is typically provided on/by a resiliently biased member. Such a resiliently biased member ensures that the electrical contacts achieve sufficient contact with one another when the cordless connector and cordless adaptor are mated together, thereby ensuring that an electrical current can flow therebetween.

Whilst such resiliently biased members may ensure suitable contact between respective electrical contacts, they can cause undesirable movement between the liquid heating vessel and the cordless power base. For example, where a resiliently biased member is provided which acts in a vertical direction, when the liquid heating vessel is empty, the force applied by the resiliently biased member may cause the liquid heating vessel to at least partially separate from the cordless power base. In this instance, the liquid heating vessel may be free to rock, i.e. wobble, on the cordless power base.

In other instances, for example where the resiliently biased member acts in a horizontal manner, the resiliently biased member may prevent movement of the liquid heating vessel relative to the cordless power base, in situations where movement is actually desired. For example, the resiliently biased member acting in a horizontal manner may cause the cordless power base to stick to, and thus lift with, the liquid heating vessel when a user lifts the liquid heating vessel away from the cordless power base.

The Applicant has appreciated that the two scenarios set out above are typically not desirable. The present invention aims to address, or at least mitigate, at least one of the problems outlined above. When viewed from a first aspect, the present invention provides a liquid heating appliance comprising:
a liquid heating vessel comprising a cordless electrical adaptor; and
a cordless power base arranged to support the liquid heating vessel thereon, wherein the cordless power base comprises a cordless electrical connector arranged to mate with the cordless electrical adaptor when the liquid heating vessel is seated on the cordless power base; wherein:
   at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
   at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
   the vertical force applied by the at least one resiliently biased vertically acting member and the horizontal force applied by the at least one resiliently biased horizontally acting member are pre-set such that:
   when the liquid heating vessel is seated on the cordless power base: the vertical force is unable to overcome: the weight of the liquid heating vessel, empty of any liquid, and the frictional force; such that the cordless electrical adaptor does not separate from the cordless electrical connector; and
   when the liquid heating vessel is lifted away from the cordless power base: the vertical force combined with a weight of the cordless power base overcomes the frictional force such that the cordless electrical connector freely separates from the cordless electrical adaptor.

The Applicant has appreciated that by suitably pre-setting the vertical force applied by the at least one resiliently biased vertically acting member and the horizontal force applied by the at least one horizontally acting member, taking into account the weight of the liquid heating vessel and the weight of the cordless power base, it is possible to achieve an arrangement whereby rocking/wobbling, is eliminated, whilst simultaneously ensuring that the cordless power base freely separates from the liquid heating vessel when the liquid heating vessel is separated therefrom.

When the liquid heating vessel is seated on the cordless power base, this is intended to mean that the liquid heating vessel is seated on the cordless power base absent of any other external forces applied by a user, e.g. there is no lifting force applied by a user. When the liquid heating vessel is seated on the cordless power base, the vertical force, applied by the resiliently biased vertically acting member, effectively acts to try and separate the cordless electrical connector and cordless electrical adaptor (and thus the liquid vessel and the cordless power base). However, this separation is resisted by two forces. Firstly, it is resisted by the weight of the liquid heating vessel. Secondly, it is resisted by the frictional force generated by the at least one resiliently biased horizontally acting member. In accordance with the invention, the vertical force applied by the at least one resiliently biased vertically acting member and the horizontal force applied by the at least one resiliently biased horizontally acting member are pre-set such that the vertical force is unable to overcome the weight of the liquid heating vessel and the frictional force (generated from the horizontal force). As the intention in this state is for the avoidance of separation of the liquid heating vessel from the cordless power base, the frictional force which resists movement will be a static frictional force.

In contrast, when the liquid heating vessel is lifted away from the cordless power base, this is intended to mean that the liquid heating vessel is actively lifted, e.g. by a user picking up the liquid heating vessel. When a user lifts the liquid heating vessel, the weight of the liquid heating vessel is effectively neutralised as the weight force of the liquid heating vessel is balanced out by the lifting force applied by a user. Thus, when a user lifts the liquid heating vessel, the weight of the liquid heating vessel no longer impacts the separation of the cordless electrical connector and cordless electrical adaptor. When lifting the liquid heating vessel, as set out above, it is desirable for the cordless power base to freely separate from the liquid heating vessel. With regard to the cordless power base, it is the weight of the cordless power base which acts to hold the cordless power base down, e.g. against a surface on which it is placed. The vertical force applied by the at least one resiliently biased vertically acting member acts to separate the cordless electrical connector and cordless electrical adaptor (and thus the liquid heating vessel and the cordless power base). When lifting the liquid heating vessel, this vertical force may be considered to be acting in a downwards direction, pushing the cordless electrical connector (and thus the cordless power base) downwards.

In this lifting scenario, the force which acts to resist the separation of the cordless electrical connector and adaptor is again the horizontal force applied by the at least one resiliently biased horizontally acting member. This generates a frictional force which resists separation. However, in accordance with the invention, by pre-setting the vertical force and the horizontal force, the Applicant has appreciated that it is possible for the weight of the cordless power base and the vertical force to overcome the frictional force, thereby allowing the cordless power base to separate smoothly from the liquid heating vessel. In this case, the weight of the cordless power base and vertical force may overcome the frictional force which may initially comprise a static frictional force, and subsequently comprise a kinetic frictional force, as the connector and adaptor begin moving relative to one another.

Accordingly, in line with the above, by suitably pre-setting the vertical and horizontal forces, the Applicant has appreciated that it is possible to avoid separation of the liquid heating vessel from the cordless power base when the vessel is seated thereon, whilst simultaneously achieving smooth separation of the liquid heating vessel and the cordless power base when the liquid heating vessel is actively lifted.

When the liquid heating vessel is lifted away from the cordless power base, the cordless electrical connector freely separates from the cordless electrical adaptor. This free separation is intended to mean that the connector and adaptor separate smoothly in a manner in which the cordless power base, e.g. any part thereof, does not lift away from the surface, e.g. work surface, on which it is arranged.

Pre-setting of the vertical force applied by the at least one vertically acting member, and the horizontal force applied by the at least one horizontally acting member, may be achieved in any suitable manner. For example, pre-setting of these forces may comprise choosing/setting a spring constant of the resilient bias of the respective resiliently biased member so as to achieve the desired balancing of the forces. It may also comprise suitably positioning the vertically acting and horizontally acting members such that they generate the desired force when they are deflected when the cordless electrical connector and cordless electrical adaptor are mated together.

Where separation is discussed above, this is intended to mean vertical separation of the cordless electrical connector and the cordless electrical adaptor, and/or vertical separation of the liquid heating vessel and the cordless power base. As the cordless electrical adaptor is part of the liquid heating vessel, and the cordless electrical connector is part of the cordless power base, it will be appreciated that movement of the cordless electrical connector relative to the cordless electrical adaptor results in corresponding movement of the liquid heating vessel relative to the cordless power base.

With regard to the at least one resiliently biased vertically acting member, this may be arranged on the cordless electrical adaptor and contact the cordless electrical connector when the cordless electrical connector and cordless electrical adaptor are mated together. In other embodiments, the at least one resiliently biased vertically acting member may be arranged on the cordless electrical connector and contact the cordless electrical adaptor when the cordless electrical connector and adaptor are mated together.

The cordless liquid heating appliance may be considered to be a cordless liquid heating apparatus.

The at least one resiliently biased vertically acting member may have any suitable form. In a set of embodiments, the at least one resiliently biased vertically acting member comprises a resiliently biased plunger, and wherein the plunger is arranged to operate an electrical switch arrangement. The plunger may thus perform the function of providing a vertical force which assists with the separation of the cordless power base from the liquid heating vessel when the vessel is being separated from the cordless power base, whilst also acting to operate the electrical switch arrangement. The plunger may be formed of an electrically insulative material. The electrical switch arrangement may provide a means for selectively making or breaking an electrical power supply circuit for supplying power, e.g. to an electrical component, to the liquid heating appliance. For example, an operational state, e.g. an open or closed state, of the electrical switch may determine the supply of electrical power to a heating element arranged within the liquid heating vessel. The electrical switch arrangement may be capable of adopting an open state, in which electrical current cannot flow through the switch, and a closed state in which electrical current is able to flow through the switch.

The plunger may be configured such that when the liquid heating vessel is seated on the cordless power base, the plunger is pushed against its resilient bias, thereby generating the vertically acting force. In contrast, when the liquid heating vessel is separated from the cordless power base, the plunger may move into an extended position under the resilient bias.

The plunger may be part of the cordless electrical connector. The plunger may extend from the cordless electrical connector so as to contact the cordless electrical adaptor when the liquid vessel is seated on the cordless power base. In this instance, the electrical switch arrangement may be arranged in the cordless power base. However, in a set of embodiments, the plunger extends from the cordless electrical adaptor. In such embodiments, the switch arrangement may also be arranged within the liquid heating vessel. The electrical switch arrangement may be part of the cordless electrical adaptor itself, or a part connected thereto, e.g. a control arrangement as discussed in detail further below.

The plunger may operate the electrical switch arrangement in any suitable manner. For example, the plunger may act to cause the electrical switch arrangement to adopt a closed state when the liquid heating vessel is separated from the cordless power base. However, in a set of embodiments, the plunger is arranged to cause the electrical switch arrangement to adopt an open state when the liquid heating vessel is separated from the cordless power base. The electrical switch arrangement may comprise at least two electrical switch contacts which contact one another when the switch is in a closed state and which are separated from one another when the switch is in an open state. As such, in embodiments as set out above, when the liquid heating vessel is separated from the cordless power base, i.e. lifted away therefrom, the plunger causes the electrical switch arrangement to adopt an open state, e.g. wherein the two electrical switch contacts are separated from one another. Such embodiments may be considered to be a lift-off-switch-off (LOSO) or lift-off-contacts-open (LOCO) arrangement as when the liquid heating vessel is lifted, the contacts are separated such that the liquid heating vessel is either switched off, or the contacts are open. In these embodiments, when the liquid heating vessel is lifted away from the cordless power base, the supply of power to an electrical component, e.g. a heating element, within the liquid heating vessel may be cut off before the electrical contacts in the connector and adaptor disconnect from one another.

In another set of embodiments, the electrical switch arrangement comprises a latch which is capable of moving into a latching position which holds the electrical switch arrangement in an open state, and wherein the plunger is arranged to move the latch out of the latching position into a non-latching position, which allows the electrical switch arrangement to adopt a closed state, when the liquid heating vessel is separated from the cordless power base. In such embodiments, another component, e.g. a thermally sensitive actuator, may act on the electrical switch arrangement to move it into the open state. The latch may be resiliently biased into the latching position, and may thus automatically adopt the latching position when the electrical switch arrangement is in an open state. As the latch functions to prevent movement of the switch arrangement from its open to its closed state, in acting on the latch, the plunger may be considered to be acting on the electrical switch arrangement. In moving the latch to allow the electrical switch arrangement to adopt the closed state, when the liquid heating vessel is separated from the cordless power base, the switch may adopt its closed state. This may be considered to be a resetting of the electrical switch arrangement, and may be known in the art as lift-off-reset (LOR). The plunger may act directly on the latch, moving it into its non-latching position which allows the switch to adopt a closed state when the liquid heating vessel is lifted and separated from its cordless power base. Alternatively, the plunger may comprise or act on any number of intermediate members which drive suitable movement of the latch.

Whilst the embodiments above comprise a plunger as a vertically acting member, this is not the only form of possible vertically acting member. In another set of embodiments, the at least one resiliently biased vertically acting member comprises a resiliently biased vertically acting electrical contact. The resiliently biased vertically acting contact may take any suitable form and may apply a vertical force to a corresponding, e.g. fixed, contact in the other of the cordless electrical connector or adaptor. The resiliently biased vertically acting contact may, for example, be arranged on the cordless electrical connector and be arranged to mate with a corresponding electrical contact in the cordless electrical adaptor. The corresponding electrical contact may be in the form of a conductive pin arranged in the cordless electrical adaptor. The conductive pin may be arranged in the centre of the cordless electrical adaptor, and a part of the resiliently biased vertically acting contact which contacts the pin may be arranged centrally in the cordless electrical connector. The conductive pin may be fixed in position.

In some embodiments only a single resiliently biased vertically acting member may be provided. In such embodiments, the entire vertical force may be provided by such a member. However, in other embodiments, the at least one resiliently biased vertically acting member comprises a plurality of resiliently biased vertically acting members. For example, the plurality of resiliently biased vertically acting members may comprise a plunger and a resiliently biased vertically acting electrical contact, as set out above. In embodiments comprising multiple resiliently biased vertically acting members, e.g. a resiliently biased plunger together with a resiliently biased vertically acting contact, the vertical force may be the sum of the vertical forces of each of the vertically acting members, i.e. the vertical force from the plunger and the vertically acting contact combined. Pre-setting of the vertical force may thus comprise suitably setting the vertical force provided by each of the vertically acting members, e.g. the plunger and the vertically acting contact. In some embodiments, however, the vertical force applied by one of such members may be fixed, e.g. due to needing to meet particular requirements. In such embodiments, the vertical force may then be pre-set by suitably setting the vertical force generated by the other/remaining vertically acting members.

The horizontal force applied by the at least one resiliently biased horizontally acting member causes a frictional force between the cordless electrical connector and adaptor. This frictional force acts to resist movement of the cordless electrical connector relative to the adaptor and thus resists the vertical force applied by the at least one resiliently biased vertically acting member. When the cordless electrical connector and cordless electrical adaptor are stationary with respect to one another, the horizontal force generates a static frictional force which resists movement of the two components. When the cordless electrical connector and the cordless electrical adaptor are moving relative to one another, the horizontal force generates a kinetic frictional force which resists movement of the two components. The at least one resiliently biased horizontally acting member may have any suitable form. For example, the at least one horizontally acting member may comprise a horizontally acting plunger, which is not electrically conductive. Such a horizontally acting plunger may function solely to resist movement of the connector relative to the adaptor. However, the Applicant has recognised that it may be advantageous to provide the horizontal force using another component so as to provide a dual function. Thus, according to a set of embodiments, the at least one resiliently biased horizontally acting member comprises at least one resiliently biased horizontally acting electrical contact. In such embodiments, the at least one resiliently biased horizontally member may function to provide the horizontal force and provide a means for electrical connection between the cordless electrical connector and the cordless electrical adaptor.

The at least one resiliently biased horizontally acting member may be arranged on the connector and/or the adaptor. However, in a set of embodiments, the at least one resiliently biased horizontally acting member is arranged on the cordless electrical connector. In embodiments wherein the at least one resiliently biased horizontally acting member comprises at least one resiliently biased horizontally acting electrical contact, a corresponding, e.g. fixed, electrical contact may be arranged in the cordless electrical adaptor and be positioned to contact the at least one resiliently biased horizontally acting electrical contact when the cordless electrical connector and adaptor are mated together. Arranging a resiliently biased horizontally acting electrical contact in the cordless base connector may advantageously allow at least one corresponding fixed electrical contact to be provided on the cordless electrical adaptor and thus reduce the overall number of parts needed on the adaptor and connector. The resiliently biased horizontally acting contact may be susceptible to damage and being moved out of position. The cordless electrical connector may comprise an integrated structure, e.g. formed in the body of the connector, which at least partially encloses the resiliently biased horizontally acting electrical contact, as well as any other such contacts. Accordingly, arranging the resiliently biased horizontally acting electrical contact in the cordless electrical connector may avoid the need to provide a separate movable shutter which protects the contacts in the cordless base connector. The corresponding fixed electrical contacts in the cordless electrical adaptor may not be protected by any such corresponding structure, however this may not be an issue as the cordless electrical adaptor is not connected to mains electricity when the liquid heating vessel is separated from the cordless power base and so poses less risk if touched. Further, the fixed contacts can be made more robust so as to be less susceptible to damage if they are touched.

The at least one resiliently biased horizontally acting electrical contact may have any suitable form for contact with a corresponding electrical contact. However, in a set of embodiments, the at least one resiliently biased horizontally acting electrical contact comprises an initial contact surface arranged to touch a corresponding electrical contact, on the other of the cordless electrical connector or cordless electrical adaptor, when the cordless electrical connector and cordless electrical adaptor begin to be coupled together, and wherein an angle between vertical and the initial contact surface is less than 40°, e.g. less than 30°, e.g. less than 20°.

The Applicant has recognised that by having an initial contact surface which has a shallow angle, i.e. less than 40°, e.g. less than 30°, e.g. less than 20°, relative to vertical, may reduce the initial resistance force experienced by the liquid vessel when placed on the cordless power base. This may improve the ease, and feel, of placement of the liquid heating vessel on the cordless power base.

The Applicant has also appreciated that the same effect may also be achieved, and/or further improved, by providing a similar initial contact surface on the contact with which the resiliently biased horizontally acting electrical contacts comes into contact with. Thus, in another set of embodiments, the appliance further comprises at least one corresponding electrical contact which the at least one resiliently biased horizontally acting electrical contact comes into contact with, when the cordless electrical connector and cordless electrical adaptor are mated together;

and wherein the at least one corresponding electrical contact comprises an initial contact surface with which the at least one resiliently biased horizontally acting electrical contact initially touches when the cordless electrical connector and cordless electrical adaptor begin to be coupled together, and wherein an angle between vertical and the initial contact surface is less than 40°, e.g. less than 30°, e.g. less than 20°. This may similarly reduce the force initially experienced as the liquid heating vessel is placed on the cordless power base and thus improve the ease, and feel, of placement of the liquid heating vessel on the cordless power base.

It may be possible to generate a sufficiently large frictional force (from the horizontal force) to resist movement of the liquid heating vessel when it is seated on the cordless power base, whilst simultaneously allowing separation of the cordless power base from the liquid heating vessel when it is lifted therefrom, using a single resiliently biased horizontally acting member. However, in a set of embodiments, the at least one resiliently biased horizontally acting member comprises a plurality of resiliently biased horizontally acting members.

Each of the resiliently biased horizontally acting members may comprise a resiliently biased horizontally acting electrical contact. The use of multiple resiliently biased horizontally acting members may reduce the amount of horizontal force that needs to be applied by any single resiliently biased horizontally acting member. The reduced force for a given horizontally acting member may act to increase the life-span of the member.

In a further set of embodiments, the plurality of resiliently biased horizontally acting members are angularly distributed around the cordless electrical connector or cordless electrical adaptor. The Applicant has recognised that by angularly distributing the plurality of resiliently biased horizontally acting members around the cordless electrical connector or cordless electrical adaptor, the horizontal force applied by said members may be more evenly distributed, and thus the frictional force generated may be distributed around the connector/adaptor. This may help to prevent the liquid heating vessel from tipping to one side when the liquid heating vessel is seated on the cordless power base. In a similar manner, it may help to ensure that the cordless power base uniformly separates from the liquid heating vessel, i.e. it is not caused to lift on one side as the liquid heating vessel is separated therefrom. The plurality of resiliently biased vertically acting members may be angularly displaced around an axis, e.g. a central axis, extending through the cordless electrical connector or cordless electrical adaptor.

The vertical force and horizontal force may be pre-set for each different liquid heating appliance, specifically for each different liquid heating vessel and cordless power base, as the weight of the liquid heating vessel and the weight of the cordless power base will impact the required forces. However, the Applicant has appreciated that the forces may be pre-set based on a lightest plausible liquid heating vessel and corresponding lightest cordless power base. The Applicant has appreciated that if the vertical forces are set for the lightest plausible liquid heating vessel and cordless power base, even if the connector and adaptor are employed in a heavier liquid heating vessel, the vertical force will still be unable to overcome the weight of the liquid heating vessel and the frictional force and thus the liquid heating vessel will still be prevented from separating from the cordless power based when the liquid heating vessel is seated on the cordless power base. In a similar manner, if a heavier cordless power base is used, the balance of forces will still ensure that the cordless power base is able to freely separate from the liquid heating vessel, when the liquid heating vessel is lifted therefrom. Accordingly, in a set of embodiments, the vertical force and horizontal force are pre-set based on a theoretical liquid heating vessel weight, when empty of any liquid, of between 450 g-550 g, e.g. 500 g, e.g. 530 g. In another set of embodiments, the vertical force and horizontal force are pre-set based on a theoretical cordless power base weight of between 60 g-100 g, e.g. 75 g.

The Applicant considers the weights set out above to be the minimum plausible weight for a liquid heating vessel and a cordless power base. The forces may be pre-set assuming the weights set out above, but in a given liquid heating appliance, the actual weight of the liquid heating vessel and the weight of the cordless power base may be heavier than the weights set out above. Through use of the theoretical weights set out above, a single cordless electrical connector and cordless electrical adaptor, having pre-set forces, may be suitable for use in a greater number of liquid heating appliances.

The liquid heating vessel and the cordless power base may comprise any suitable electrical components therein. In a set of embodiments, the liquid heating vessel comprises an electrical heating arrangement configured to heat the contents of the liquid heating vessel. The liquid heating arrangement may, for example, comprise a resistive heating arrangement. In alternative embodiments, the heating arrangement may comprise an inductive heating arrangement, e.g. comprising an inductive coil and a susceptor element arranged to heat the contents of the liquid heating vessel. Any other suitable electrical component may also be provided and supplied with power from the cordless electrical connector and adaptor. For example, the liquid heating vessel may comprise a motorized stirrer/agitator arranged to stir/agitate the contents of the liquid heating vessel. An electronic controller, e.g. comprising a processor, may be arranged in the liquid heating vessel and/or in the cordless power base.

The cordless electrical adaptor may be a standalone component within the liquid heating vessel, and the cordless electrical adaptor may be connected directly to an electrical component, e.g. a heating arrangement, within the liquid heating vessel. However, in a set of embodiments, the cordless electrical adaptor is part of a cordless electrical control arranged in the liquid heating appliance. The cordless electrical control may comprise any suitable means for controlling operation of the liquid heating vessel. Electrical components within the liquid heating vessel may be electrically connected to the cordless electrical control. The cordless electrical control may, for example, comprise an overheat detection means configured to detect overheating of the liquid heating appliance. This may, for example, comprise a thermally sensitive actuator, e.g. a bimetallic actuator, arranged to detect the overheating of a heating element, or a part in contact therewith. The cordless electrical control may also comprise means for monitoring the temperature of the contents of the liquid heating vessel. The means for monitoring the temperature may comprise a thermo-mechanical arrangement for monitoring the temperature. Alternatively, it may comprise an electronic temperature sensor, e.g. a thermistor and suitable control circuitry.

The cordless electrical connector and adaptor may be suitably formed such that they only permit arrangement of the liquid heating vessel on the cordless power base in a limited number, e.g. one or two, angular orientations. However, in a set of embodiments, the cordless electrical adaptor is a 360° cordless electrical adaptor and wherein the cordless electrical connector is a corresponding 360° cordless electrical connector, such that the liquid heating vessel can be received at any angular orientation on the cordless power base. As will be appreciated, such a connector and adaptor may improve the ease of use of the liquid heating appliance.

The cordless electrical connector and adaptor may comprise any suitable number of electrical contacts. In a set of embodiments, the cordless electrical adaptor and cordless electrical connector facilitate power transfer and/or data transfer between the liquid heating vessel and the cordless power base. Where the cordless electrical adaptor and connector are only for transferring power between the liquid heating vessel and cordless power base, the cordless electrical connector and adaptor may, for example, each comprise two or three corresponding electrical contacts, depending on whether a particular jurisdiction requires the provision of an earth connection. Where the cordless electrical connector and adaptor are for transferring both power and data, the cordless electrical connector and adaptor may, for example, each comprise four or five corresponding electrical contacts, again depending on whether a particular jurisdiction requires the provision of an earth connection. Of course, the electrical connector and adaptor may comprise any suitable number of electrical contacts depending on the particular requirements of the connector and adaptor.

In some embodiments, the cordless electrical connector and the cordless electrical adaptor may each be a 3-pole connector/adaptor. In such embodiments, each of the connector and adaptor may comprise three electrical contacts. In some embodiments, the cordless electrical adaptor may comprise three fixed electrical contacts, e.g. a contact pin and two annular electrical contacts. The corresponding cordless electrical connector may comprise three resiliently biased electrical contacts. In some embodiments, all three of the resiliently biased electrical contacts may be resiliently biased horizontally acting electrical contacts. In other embodiments, one of the contacts, e.g. a central contact, may be a resiliently biased vertically acting electrical contact, and the other two electrical contacts may be resiliently biased horizontally acting electrical contacts.

In other embodiments, the cordless electrical connector and the cordless electrical adaptor may each be a 5-pole connector/adaptor. In such embodiments, each of the cordless electrical connector and cordless electrical adaptor may comprise five electrical contacts. Similarly, to the embodiments discussed above, the cordless electrical adaptor may comprise five fixed electrical contacts, e.g. a central conductive pin, surrounded by four annular electrical contacts. In such embodiments, the cordless electrical connector may comprise five resiliently biased electrical contacts. The five resiliently biased electrical contacts may comprise any combination of resiliently biased horizontally acting electrical contacts and resiliently biased vertically acting electrical contacts.

In either of the 3-pole or 5-pole embodiments discussed above, the cordless electrical connector and/or adaptor may further comprise a resiliently biased vertically acting member in the form of a plunger, as discussed in relation to embodiments above.

In any of the embodiments described above, the resilient bias of either the at least one vertically acting member or the at least one resiliently biased vertically acting member may be provided in any suitable manner. For example, the resilient bias may be provided by a separate spring element, e.g. a coiled spring. Taking the plunger, for example, a coiled spring may act on the plunger to provide the resilient bias. In other embodiments, the resilient bias may be provided by a spring element that is integrally formed with the resiliently biased vertically/horizontally acting member. For example, the resiliently biased vertically/horizontally acting member may be formed from a resiliently deformable material that provides a resilient bias when it is deformed. Deformation may, for example, comprise bending of the vertically/horizontally acting member. The vertically/horizontally acting member may comprise an arm portion that facilitates the deformation of the respective member and that provides the resilient bias when it is bent away from its resting position.

The Applicant has appreciated that the present invention is not limited to the entire liquid heating appliance and thus when viewed from a second aspect provides a cordless connection arrangement for a liquid heating appliance comprising a liquid heating vessel and a cordless power base, the cordless connection arrangement comprising:
a cordless electrical adaptor configured to be mounted on the liquid heating vessel; and
a cordless electrical connector configured to be mounted on the cordless power base; wherein
   at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
   at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
   the vertical force applied by the at least one resiliently biased vertically acting member and the horizontal force applied by the at least one resiliently biased horizontally acting member are pre-set such that, when the cordless electrical adaptor is mounted on a liquid heating vessel and the cordless electrical connector is mounted on a cordless power base:
   when the liquid heating vessel is seated on the cordless power base: the vertical force is unable to overcome: the weight of the liquid heating vessel, empty of any liquid, and the frictional force; such that the cordless electrical connector does not separate from the cordless base adaptor; and
   when the liquid heating vessel is lifted away from the cordless power base: the vertical force combined with a weight of the cordless power base overcomes the frictional force such that the cordless electrical connector freely separates from the cordless electrical adaptor.

Any of the features of the embodiments of the first aspect of the invention discussed above may be applied to this second aspect of the present invention.

According to a third aspect of the present invention, there is provided a liquid heating appliance comprising:
a liquid heating vessel comprising a cordless electrical adaptor; and
a cordless power base arranged to support the liquid heating vessel thereon, wherein the cordless power base comprises a cordless electrical connector arranged to mate with the cordless electrical adaptor when the liquid heating vessel is seated on the cordless power base; wherein:
   at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
   at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
   the vertical force applied by the at least one resiliently biased vertically acting member and the horizontal force applied by the at least one resiliently biased horizontally acting member are pre-set such that the forces acting between the cordless power base and the liquid heating vessel are balanced so that when the liquid heating vessel is seated on the cordless power base the liquid heating vessel does not separate from the cordless power base and when the liquid heating vessel is lifted away from the cordless power base the cordless power base freely separates from the liquid heating vessel.

Any of the features of the embodiments of the first aspect of the present invention may be applied to this third aspect of the present invention.

According to a fourth aspect of the present invention there is provided a liquid heating appliance comprising:
a liquid heating vessel comprising a chamber for receiving a liquid to be heated and a cordless electrical adaptor; and
a cordless power base arranged to support the liquid heating vessel thereon, wherein the cordless power base comprises a cordless electrical connector arranged to mate with the cordless electrical adaptor when the liquid heating vessel is seated on the cordless power base; wherein:
   at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
   at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
   the vertical force applied by the at least one resiliently biased vertically acting member and the horizontal force applied by the at least one resiliently biased horizontally acting member are pre-set such that:
   when the liquid heating vessel is seated on the cordless power base: the vertical force is unable to overcome: the weight of the liquid heating vessel, empty of any liquid, and the frictional force; such that the cordless electrical adaptor does not separate from the cordless electrical connector; and
   when the liquid heating vessel is lifted away from the cordless power base: the vertical force combined with a weight of the cordless power base overcomes the frictional force such that the cordless electrical connector freely separates from the cordless electrical adaptor.

Any of the features of the embodiments of the first aspect of the present invention may be applied to this fourth aspect of the present invention.

In any of the aspects or embodiments described above, a vertically acting member is a member that applies at least a component of vertical force. The vertically acting member may also impart a component of horizontal force. In a similar manner, in any of the aspects or embodiments described above, a horizontally acting member is a member that applies at least a component of horizontal force. The horizontally acting member may also impart a component of vertical force.

The liquid heating appliance of any of the aspects or embodiments discussed above may be suitable for heating any appropriate liquid. For example, the liquid heating appliance may be suitable for heating water. In such embodiments, the liquid heating appliance may be considered to be a kettle. In addition, or alternatively, the liquid heating appliance may be suitable for heating other types of liquid, e.g. milk, tea or coffee.

Some preferred embodiments of the present invention will now be described, by way of example, only, and with reference to the accompanying drawings, in which:

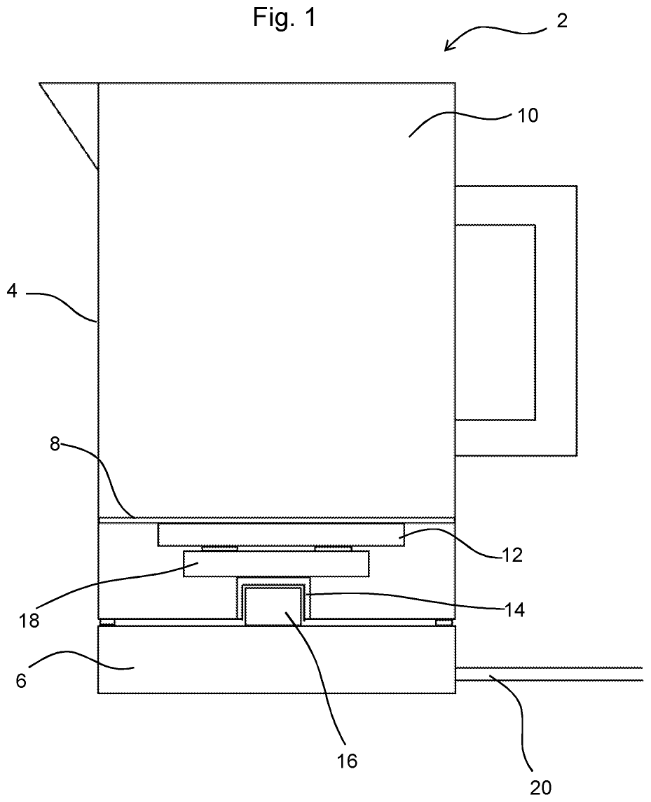

FIG. 1 shows a schematic view of a liquid heating appliance in accordance with an embodiment of the present invention;

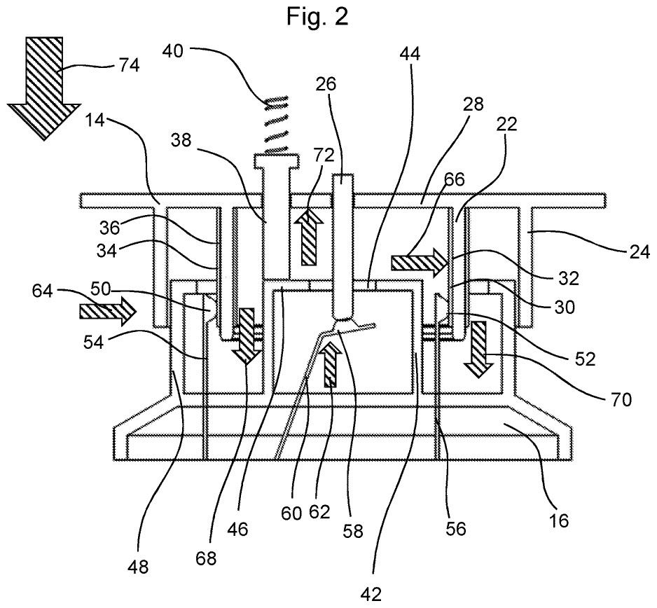

FIG. 2 shows a sectional view of the cordless electrical connector and adaptor shown in FIG. 1 in a mated configuration;

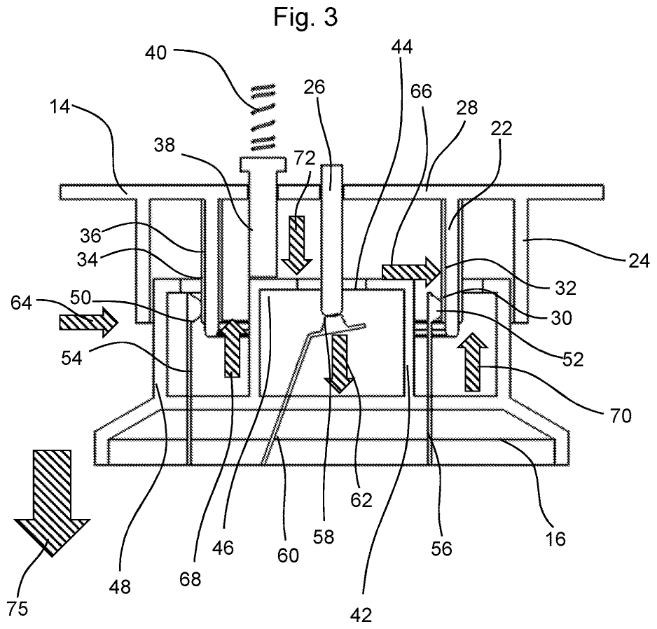

FIG. 3 shows a sectional view of the cordless electrical connector and adaptor shown in FIG. 2 when the liquid heating vessel is lifted from the cordless power base;

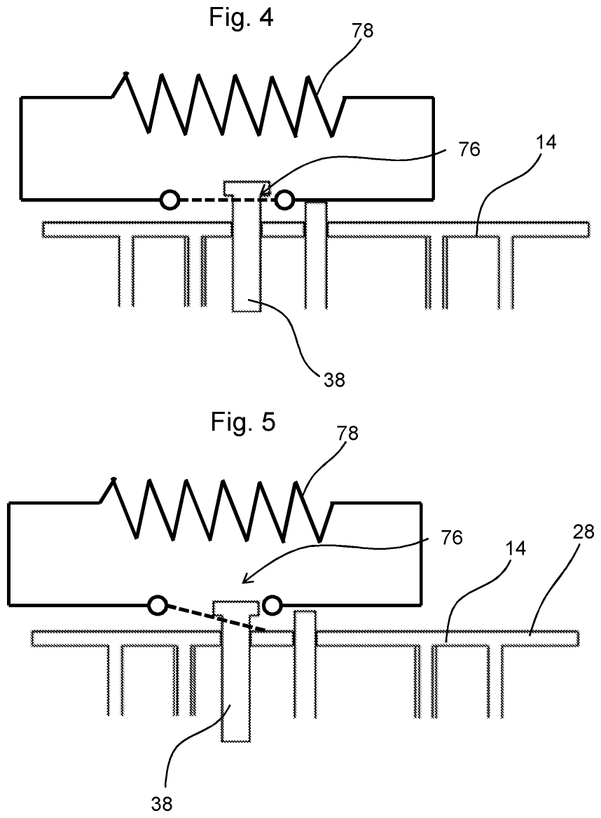

FIG. 4 shows a schematic view of a plunger, of the cordless electrical adaptor shown in FIG. 2 and FIG. 3 in combination with an electrical switch arrangement;

FIG. 5 shows a schematic view of the plunger acting to move the electrical switch arrangement into an open state.

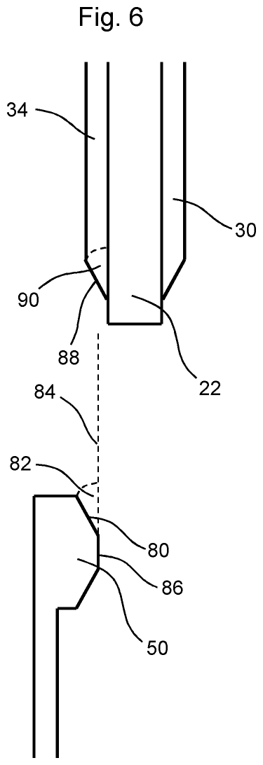

FIG. 6 shows a sectional view of one of the horizontally acting members and a corresponding fixed electrical contact, showing the initial contact surfaces thereof;

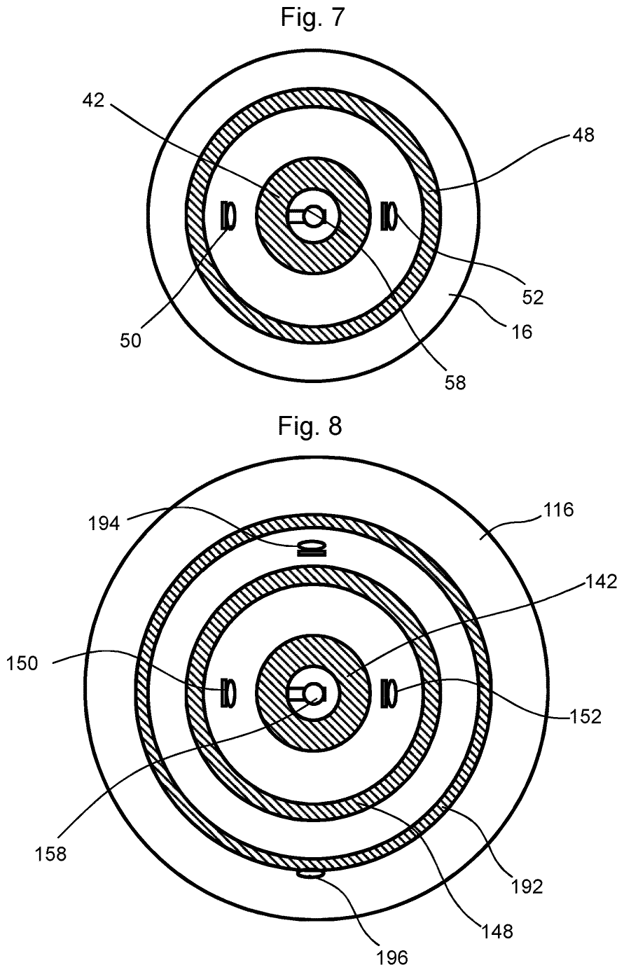

FIG. 7 shows a top-down view of the cordless electrical connector shown in earlier Figs.

FIG. 8 shows a top-down view of a 5-pole cordless electrical connector in accordance with another embodiment of the present invention; and

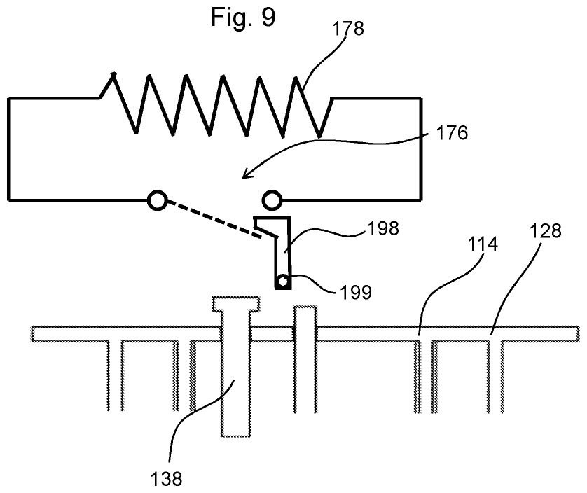

FIG. 9 shows a schematic view of the plunger operating to move a latch, which holds an electrical switch arrangement in an open state.

FIG. 1 shows a schematic view of a liquid heating appliance 2 in accordance with an embodiment of the present invention. In the embodiment depicted, the liquid heating appliance 2 is in the form of a kettle. However, it will be appreciated that the liquid heating appliance 2 may be in any suitable form, e.g. in the form of a milk heating and frothing appliance. The liquid heating appliance 2 comprises a liquid heating vessel 4 and a cordless power base 6. The cordless power base 6 is shaped to receive the liquid heating vessel 4 thereon. In some embodiments, as depicted, the liquid heating vessel 4 comprises a heated base 8 which defines a liquid chamber 10 which receives a liquid to be heated. The heated base 8 may be heated by a heating element 12.

The liquid heating vessel 4 comprises a cordless electrical adaptor 14 (hereinafter “adaptor 14”) arranged to mate with a cordless electrical connector 16 (hereinafter “connector 16”) provided on the cordless power base 6. In some embodiments, as depicted, the adaptor 14 is part of a cordless electrical control 18 which controls the supply of electrical power to the heating element 12. The cordless electrical control 18 may comprise suitable means for monitoring the temperature of the heating element 12 and/or the liquid contents of the liquid heating vessel 4.

The cordless power base 6 comprises a power cable 20 which may be plugged into a suitable power source, e.g. a mains electric power supply. The power cable 20 may be suitably electrically connected to the cordless electrical connector 16, e.g. to electrical contacts therein. When the liquid heating vessel 4 is arranged on the cordless power base 6, thereby mating the adaptor 14 and connector 16, electrical power is able to pass from the cordless power base 6 to the liquid heating vessel 4 via the connector 16 and adaptor 14.

FIG. 2 shows a schematic sectional view of an embodiments of adaptor 14 and connector 16 in the mated arrangement shown in FIG. 1, i.e. when the liquid heating vessel 4 is seated on the cordless power base 6. When the liquid heating vessel 4 is seated on the cordless power base 6, the liquid heating vessel 4 is free of any other forces from a user.

As depicted, the adaptor 14 may comprise a first annular wall 22 and a second annular wall 24 which extend from a base portion 28. The adaptor 14, e.g. the first annular wall 22, second annular wall 24 and base portion 28 may be formed from a moulded plastic body. A centrally arranged contact pin 26 extends through the base portion 28. The contact pin 26 is fixed in position and thus provides no resilient bias to the connector 16 when in the mated configuration. A first annular electrical contact 30 is arranged on a first side 32 of the first annular wall 22 and a second annular electrical contact 34 is arranged on second side 36 of the first annular wall 22. The contact pin 26, first annular electrical contact 30 and second annular electrical contact 34 may be suitably connected to electrical components within the liquid heating vessel. For example, the first and second annular electrical contacts 30, 34 may provide a live and neutral connection to the heating element 18 or any other electrically powered component within the liquid heating vessel. The contact pin 26 may provide an earth connection to the liquid heating vessel 4. Whilst a specific form of adaptor 14 is described above, it will be appreciated that the adaptor 14 may have any suitable form. For example, the electrical contacts therein may be arranged in any other suitable configuration. In some embodiments, the adaptor 14 may be devoid of at least the first annular wall 22 and the first and second annular contacts 30, 34 may instead be separated by an air gap.

The cordless electrical adaptor 14 further comprises a first resiliently biased vertically acting member 38. In the embodiment depicted, the resiliently biased vertically acting member 38 is in the form of a plunger 38. The resiliently biased vertically acting member 38 is resiliently biased by a spring 40. However, it will be appreciated that the resiliently biased vertically acting member 38 may, in other embodiments, be resiliently biased by any other suitable resilient bias, or indeed be resiliently biased by the form and/or material of the resiliently biased vertically acting member 38 itself. The force applied by the resiliently biased vertically acting member 38 is shown schematically by arrow 72.

In the embodiment depicted in FIG. 2, the connector 16 comprises an upstanding cylindrical boss 42 with a central opening 44 in an upper wall 46 thereof. The central opening 44 is dimensioned to receive the contact pin 26, of the adaptor 14, when the adaptor 14 and connector 16 are mated together. The connector 16 further comprises an upstanding outer annular wall 48. As will be appreciated by those skilled in the art, the cylindrical boss 42, or the outer annular wall 48 may be omitted or have any other suitable form.

In some embodiments, as depicted, the connector 16 comprises a plurality of resiliently biased horizontally acting members in the form of resiliently biased horizontally acting electrical contacts. Specifically, the connector 16 comprises a first resiliently biased horizontally acting electrical contact 50 (hereinafter “first horizontal contact 50”) and a second resiliently biased horizontally acting electrical contact 52 (hereinafter “second horizontal contact 52”). The first horizontal contact 50 comprises a first spring portion 54 which provides the horizontal resilient bias. The horizontal force applied by the first horizontal contact 50 is shown schematically by arrow 64. The second horizontal contact 52 comprises a second spring portion 56 which provides the horizontal resilient bias to the second horizontal contact 52. The horizontal force applied by the second horizontal contact 52 is shown schematically by arrow 66. The first and second spring portions 54, 56 may be formed of a material which is resiliently deformable, such that when the first and second spring portions 54, 56 are bent away from their resting position, they apply a resilient bias tending to drive the first and second spring portions 54, 56, and thus the first and second horizontal contacts 50, 52 towards their resting position in the horizontal direction.

The connector 16 further comprises a second resiliently biased vertically acting member in the form of a resiliently biased vertically acting electrical contact 58 (hereinafter “vertically acting electrical contact 58”). The vertically acting electrical contact 58 is resiliently biased by a third spring portion 60. The first and second horizontal contacts 50, 52, together with the vertically acting electrical contact 58 may be suitably connected, within the cordless power base 6, to the power supply cable 20.

When the liquid heating vessel 4 is placed onto the power base 6, the adaptor 14 and connector 16 begin to mate together until they are fully mated as shown in FIG. 2. As the adaptor 14 and connector 16 are mated together, the contact pin 26 presses against the vertically acting electrical contact 58 in the connector 16. The third spring portion 60 allows deflection of the vertically acting electrical contact 58 so as to allow the adaptor 14 to mate with the connector 16. However, in allowing this movement, the third spring portion 60 applies a resilient bias to the vertically acting electrical contact 58, thereby applying a vertical force to the contact pin 26, and thus the adaptor 14. As will be appreciated, this vertical force acts to try and separate the adaptor 14 and connector 16. The force applied by the second vertically acting electrical contact 58 is shown schematically by arrow 62.

In a similar manner, as the adaptor 14 is mated with the connector 16, the first horizontal contact 50 is deflected radially outwards by the second annular electrical contact 34 and the second horizontal contact 52 is deflected radially inwards by the first annular electrical contact 30. This deflection bends the respective first and second spring portions 54, 56. As a result, these first and second spring portions 54, 56 apply a resilient bias back to the first and second horizontal contacts 50, 52 thus providing horizontal forces against the first and second annular electrical contacts 30, 34 which they contact. These horizontal forces are depicted by arrows 64, 66. The horizontal forces 64, 66 cause the formation of frictional forces, indicated by arrows 68, 70, which act between the first and second horizontal contacts 50, 52, and the first and second annular electrical contacts 30, 34. The frictional forces 68, 70, act to resist separation of the adaptor 14 and connector 16.

When the adaptor 14 is mated with the connector 16 as shown in FIG. 2, contact between the vertically acting contact 58 and the contact pin 26, contact between the first horizontal contact 50 and the second annular electrical contact 34, and contact between the second horizontal contact 52 and the first annular electrical contact 30 provides an electrical connection between the adaptor 14 and the connector 16. This electrical connection may provide a power supply to the heating element 12, or any other electrical component within the liquid heating vessel 4.

In addition to the forces generated as set out above, when the adaptor 14 is mated with the connector 16, the resiliently biased vertically acting member 38 contacts an upper wall 46 of the central boss 42. This causes the resiliently biased vertically acting member 38 to compress the spring 40. The spring 40 thus generates a resilient bias which provides a further vertical force to be transferred through the resiliently biased vertically acting member 38 and be applied to the upper wall 46, and thus the connector 16. This further vertical force is depicted by arrow 72.

When the liquid heating vessel 4 is seated on the cordless power base 6, the weight of the liquid heating vessel 4 (which may empty of any liquid therein), at least partially, holds the liquid heating vessel 4 in contact with the cordless power base 6. The force of the weight of the liquid heating vessel 4 is illustrated by arrow 74.

In accordance with the present invention, the vertical forces 62, 72 applied by the vertically acting contact 58 and the resiliently biased vertically acting member 38 are pre-set, and the horizontal forces 64, 66, applied by the first and second contacts 50, 52 are pre-set such that the vertical forces 62, 72 are unable to overcome the weight force 74, of an empty liquid heating vessel 4, and the frictional forces 68, 70 generated by the horizontal forces 64, 66. In other words, the total vertical force (i.e. the vertical forces 62, 72 combined) is less than (or equal to) the sum of the weight force 74 and the frictional forces 68, 70. As will be appreciated by those skilled in the art, by pre-setting the forces in this manner, the adaptor 14 will not separate from the connector 16 and thus the liquid heating vessel 4 will not be able to rock or wobble on the cordless power base 6.

FIG. 3 shows a schematic sectional view of the adaptor 14 and connector 16 when the liquid heating vessel 4 is lifted away from the cordless power base 6. Reference numerals for each of the parts shown in FIG. 2 have been included on FIG. 3. When the liquid heating vessel 4 is lifted, the weight of the liquid heating vessel 4 is effectively neutralised, by the lifting force applied by the user. Accordingly, the weight force 74 (of the liquid heating vessel 4) is not shown in FIG. 3.

When the liquid heating vessel 4 is being lifted, the resiliently biased vertically acting member 38 will move relative to the base portion 28, of the adaptor 14, however it will still apply a vertical force 72. The first and second horizontal contacts 50, 52 will similarly continue to apply horizontal forces 64, 66, thereby generating frictional forces 68, 70. Similarly, the vertically acting contact 58 will continue to apply a vertical force 62. In addition to these forces, the weight of the cordless power base 6 (not visible in this Figure) acts as a downward force 75 in the system.

In addition to pre-setting the vertical and horizontal forces such that they prevent separation when the liquid heating vessel 4 is seated on the cordless power base 6, the vertical and horizontal forces are also pre-set such that when the liquid heating vessel 4 is lifted away from the cordless power base 6, the cordless power base 6 freely separates from the liquid heating vessel. This is described further with reference to the forces shown on FIG. 3.

When the liquid heating vessel 4 is actively lifted, the vertical forces 62, 72 applied by the vertically acting contact 58 and the resiliently biased vertically acting member 38 are pre-set, and the horizontal forces 64, 66, applied by the first and second contacts 50, 52 are pre-set such that the adaptor 14 freely separates from the connector 16. In this case, the vertical forces 62, 72, together with the weight force 75, of the cordless power base 6, combined is greater than the frictional forces 68, 70. This will allow the adaptor 14 and connector 16 to freely separate from one another when the liquid heating vessel 4 is lifted. In freely separating from one another, as discussed previously, the cordless power base 6 may remain firmly on a surface on which it is placed, and not lift with the liquid heating vessel 4.

In some embodiments, the resiliently biased vertically acting member 38 may also operate an electrical switch arrangement. This is depicted in FIG. 4 which shows schematically the interaction between the resiliently biased vertically acting member 38 and an electrical switch arrangement 76. The electrical switch arrangement 76 may be electrically connected to an electrical component 78 within the liquid heating vessel 4. In the embodiment depicted, the electrical component 78 is depicted as a heating element, however it will be appreciated that the electrical switch 76 may control the supply of power to any suitable electrical component.

Only the upper half of the adaptor 14 is shown for illustrative purposes. In the configuration shown in FIG. 4, the adaptor 14 is fully mated with the connector 16. In this configuration, the resiliently biased vertically acting member 38 may cause the electrical switch arrangement 76 to adopt a closed state, or allow the electrical switch arrangement 76 to adopt a closed state, e.g. under its own resilient bias. The electrical switch arrangement 76 may, in some embodiments, be arranged within the liquid heating vessel 4.

FIG. 5 shows the instance whereby the adaptor 14 has been at least partially separated from the connector 16 (not shown). As the adaptor 14 is separated from the connector 16, the resiliently biased vertically acting member 38 moves relative to the base portion 28 and causes the electrical switch arrangement 76 to adopt an open state. The vertically acting member 38 may act directly on the electrical switch arrangement 76 or act via an intermediate member. As such, when the adaptor 14 and connector 16 are separated, the electrical switch arrangement 76 adopts an open state under the action of the resiliently biased vertically acting member 38. This arrangement may be considered to be a LOCO or LOSO arrangement.

Whilst the electrical switch arrangement 76 is depicted as being part of the liquid heating vessel 4, in alternative embodiments wherein the resiliently biased vertically acting member 38 is arranged in the connector 16, instead of the adaptor 14, the electrical switch arrangement 76 may instead be located in the cordless power base 6.

FIG. 6 shows a view focussing on the first horizontal contact 50 and the second annular electrical contact 34. As shown, in some embodiments, the first horizontal contact 50 may comprise an initial contact surface 80 which contacts the second annular electrical contact 34 when the adaptor 14 and connector 16 are mated together. As depicted, the initial contact surface 80 may be inclined to vertical (indicated by dashed line 84) by an angle 82. In some embodiments, the angle 82 is less than 40°, e.g. less than 30°, e.g. less than 20°. A relatively shallow angle may improve the feel of initial mating of the adaptor 14 and connector 16. The first horizontal contact 50 may have a secondary contact portion 86 which contacts the second annular contact 34 when the adaptor 14 and connector 16 are fully mated together. Any or all of the other horizontally acting contacts may have a similar initial contact surface.

In a similar manner, the second annular electrical contact 34 may comprise an initial contact surface 88 which is inclined to vertical 84 at an angle 90 which is less than 40°, e.g. less than 30°, e.g. less than 20°. In a similar manner to the first horizontal contact 50 described above, the initial contact surface 88 may reduce the initial forces experienced as the adaptor 14 and connector 16 are mated, thus improving the feel and ease of placement. The first annular electrical contact 30 may also have a similar initial contact surface.

In some embodiments, where multiple resiliently biased horizontally acting members are included, e.g. the first and second horizontal contacts 50, 52, the multiple resiliently biased horizontally acting members may be angularly distributed around the connector and/or adaptor. FIG. 7 shows a top-down view of the connector 16 shown in earlier Figures. As is apparent from this Figure, the first and second horizontal contacts 50, 52 are arranged within the first annular wall 48. The vertically acting electrical contact 58 is arranged in the centre of the upstanding cylindrical boss 42. As is apparent from this view, the first and second horizontal contacts 50, 52 are angularly displaced around the connector 16, specifically about an axis extending through the centre of the connector 16, i.e. through the vertically acting electrical contact 58. Displacing the first and second horizontal contacts 50, 52 in this manner may distribute the horizontal forces applied to the adaptor 14, thereby ensuring a smooth separation of the connector 16 and adaptor 14 when the liquid heating vessel 4 is lifted away from the cordless power base 6. In the embodiment depicted, the first and second horizontal contacts 50, 52 are equiangularly displaced around the connector 16.

In some embodiments, the adaptor 14 is a 360° adaptor and the connector 16 is a 360° connector that allows placement of the adaptor 14 on the connector 16 (and thus placement of the liquid heating vessel 4 on the cordless power base 6) in any angular orientation. The adaptor 14 and connector 16 may have a cylindrical profile that facilitates such 360° placement.

Whilst the embodiments discussed above each include 3 electrical contacts on the adaptor 14 and connector 16, thereby forming a 3-pole connector and adaptor set, the invention is not limited to such arrangements. The Applicant has appreciated that connectors and adaptors may include further contacts. For example, the connector and adaptor may each comprise 5 electrical contacts, thereby forming a 5-pole connector and adaptor set. A connector 116 comprising five electrical contacts is depicted in FIG. 8 which shows a top-down view of the connector 116. The connector 116 is largely the same as the connector 16 discussed above, except that it comprises an additional upstanding annular wall 192. In this embodiment, the connector 116 comprises first and second horizontal contacts 150, 152 and a vertically acting electrical contact 158 that are arranged in a similar manner to the corresponding contacts in the connector 16 discussed above. The connector 116 shown in FIG. 8 comprises two further contacts. It comprises third and fourth resiliently biased horizontally acting contacts 194, 196 (hereinafter “third horizontal contact 194” and “fourth horizontal contact 196”).

As apparent from FIG. 8, the first, second, third and fourth horizontal contacts 150, 152, 194, 196 are angularly displaced around the centre of the connector 116. In the embodiment depicted, the first, second, third and fourth horizontal contacts 150, 152, 194, 196 are arranged equiangularly around the centre of the connector 116. This arrangement may ensure an even distribution of the horizontal force to a corresponding adaptor. Whilst an adaptor is not shown, a 5-contact adaptor may substantially correspond to the adaptor 14 described above, and shown in previous Figures, with the inclusion of two further contacts. These two further contacts may be arranged on either side of the second annular wall 24 shown in FIG. 2, or in any other suitable manner.

Of course, whilst 3-pole and 5-pole connectors and adaptors have been discussed above, it will be appreciated that the connector and adaptor may comprise any suitable number of contacts depending on the particular application.

FIG. 9 shows a schematic view of another embodiment of the present invention. This embodiment is similar to the embodiments discussed above in respect of FIGS. 4 and 5, except that the electrical switch arrangement 176, which is electrically connected to the electrical component 178, comprises a latch 198 capable of holding the electrical switch arrangement 176 in an open configuration. The latch 198 may move into a position whereby it holds the electrical switch arrangement 176 when the electrical switch arrangement 176 adopts an open state whilst the liquid heating vessel is arranged on the cordless power base 6. The latch 198 may be pivotally mounted about pivot 199 and maybe biased, e.g. under gravity or any other biasing means, into a latching position which latches open the electrical switch arrangement 176.

In this embodiment, when the adaptor 114 is separated from the corresponding connector (not shown), the resiliently biased vertically acting member 138, e.g. the plunger, moves relative to the base portion 128 of the adaptor 114. This movement may act to drive the latch 198 out of the latching position shown in FIG. 9, into a non-latching position whereby the electrical switch arrangement 176 is able to adopt a closed state. When the latch 198 is moved into the non-latching position, the electrical switch arrangement 176 may adopt a closed state under its own resilient bias, or the resiliently biased vertically acting member 138 may act to directly close the electrical switch arrangement 176.

In the various embodiments discussed above, the adaptor comprises fixed contacts and the connector comprises movable, resiliently biased contacts. It will be appreciated that such electrical contacts may be distributed between the connector and adaptor in any suitable manner. For example, the adaptor may instead comprise some or all resiliently biased electrical contacts and the connector may instead comprise fewer, or no, resiliently biased contacts and instead comprise fixed electrical contacts.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A liquid heating appliance comprising:
a liquid heating vessel comprising a cordless electrical adaptor; and
a cordless power base arranged to support the liquid heating vessel thereon, wherein the cordless power base comprises a cordless electrical connector arranged to mate with the cordless electrical adaptor when the liquid heating vessel is seated on the cordless power base; wherein:
at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
the vertical force applied by the at least one resiliently biased vertically acting member and the horizontal force applied by the at least one resiliently biased horizontally acting member are pre-set such that:
when the liquid heating vessel is seated on the cordless power base: the vertical force is unable to overcome: the weight of the liquid heating vessel, empty of any liquid, and the frictional force; such that the cordless electrical adaptor does not separate from the cordless electrical connector; and
when the liquid heating vessel is lifted away from the cordless power base: the vertical force combined with a weight of the cordless power base overcomes the frictional force such that the cordless electrical connector freely separates from the cordless electrical adaptor.

2. The liquid heating appliance as claimed in any claim 1, wherein the at least one resiliently biased vertically acting member comprises a resiliently biased plunger, and wherein the plunger is arranged to operate an electrical switch arrangement.

3. The liquid heating appliance as claimed in claim 2, wherein the plunger-extends from the cordless electrical adaptor.

4. The liquid heating appliance as claimed in claim 2, wherein the plunger is arranged to cause the electrical switch arrangement to adopt an open state when the liquid heating vessel is separated from the cordless power base.

5. The liquid heating appliance as claimed in claim 2, wherein the electrical switch arrangement comprises a latch which is capable of moving into a latching position which holds the electrical switch arrangement in an open state, and wherein the plunger is arranged to move the latch out of the latching position into a non-latching position, which allows the electrical switch arrangement to adopt a closed state, when the liquid heating vessel is separated from the cordless power base.

6. The liquid heating appliance as claimed in claim 1, wherein the at least one resiliently biased vertically acting member comprises a resiliently biased vertically acting electrical contact.

7. The liquid heating appliance as claimed in claim 1, wherein the at least one resiliently biased horizontally acting member comprises at least one resiliently biased horizontally acting electrical contact.

8. The liquid heating appliance as claimed in any preceding claim 1, wherein the at least one resiliently biased horizontally acting member is arranged on the cordless electrical connector.

9. The liquid heating appliance as claimed in claim 7, wherein the at least one resiliently biased horizontally acting electrical contact comprises an initial contact surface arranged to touch a corresponding electrical contact, on the other of the cordless electrical connector or cordless electrical adaptor, when the cordless electrical connector and cordless electrical adaptor begin to be coupled together, and wherein an angle between vertical and the initial contact surface is less than 40°, e.g. less than 30°, e.g. less than 20°.

10. The liquid heating appliance as claimed in claim 7, further comprising at least one corresponding electrical contact which the at least one resiliently biased horizontally acting electrical contact comes into contact with, when the cordless electrical connector and cordless electrical adaptor are mated together; and wherein the at least one corresponding electrical contact comprises an initial contact surface with which the at least one resiliently biased horizontally acting electrical contact initially touches when the cordless electrical connector and cordless electrical adaptor begin to be coupled together, and wherein an angle between vertical and the initial contact surface is less than 40°, e.g. less than 30°, e.g. less than 20°.

11. The liquid heating appliance as claimed in claim 1, wherein the at least one resiliently biased horizontally acting member comprises a plurality of resiliently biased horizontally acting members.

12. The liquid heating appliance as claimed in claim 11, wherein the plurality of resiliently biased horizontally acting members are angularly distributed around the cordless electrical connector or cordless electrical adaptor.

13. The liquid heating appliance as claimed in claim 1, wherein the vertical force and horizontal force are pre-set based on a theoretical liquid heating vessel weight, when empty of any liquid, of between 450 g-550 g, e.g. 500 g.

14. The liquid heating appliance as claimed in claim 1, wherein the vertical force and horizontal force are pre-set based on a theoretical cordless power base weight of between 60 g-100 g, e.g. 75 g.

15. The liquid heating appliance as claimed in claim 1, wherein the liquid heating vessel comprises an electrical heating arrangement configured to heat the contents of the liquid heating vessel.

16. The liquid heating appliance as claimed in claim 1, wherein the cordless electrical adaptor is part of a cordless electrical control arranged in the liquid heating appliance.

17. The liquid heating appliance as claimed in claim 1, wherein the cordless electrical adaptor is a 360° cordless electrical adaptor and wherein the cordless electrical connector is a corresponding 360° cordless electrical connector, such that the liquid heating vessel can be received at any angular orientation on the cordless power base.

18. The liquid heating appliance as claimed in any claim 1, wherein the cordless electrical adaptor and cordless electrical connector facilitate power transfer and/or data transfer between the liquid heating vessel and the cordless power base.

19. A cordless connection arrangement for a liquid heating appliance comprising a liquid heating vessel and a cordless power base, the cordless connection arrangement comprising:
a cordless electrical adaptor configured to be mounted on the liquid heating vessel; and
a cordless electrical connector configured to be mounted on the cordless power base; wherein
at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
the vertical force applied by the at least one resiliently biased vertically acting member and the horizontal force applied by the at least one resiliently biased horizontally acting member are pre-set such that, when the cordless electrical adaptor is mounted on a liquid heating vessel and the cordless electrical connector is mounted on a cordless power base:
when the liquid heating vessel is seated on the cordless power base: the vertical force is unable to overcome: the weight of the liquid heating vessel, empty of any liquid, and the frictional force; such that the cordless electrical connector does not separate from the cordless base adaptor; and
when the liquid heating vessel is lifted away from the cordless power base: the vertical force combined with a weight of the cordless power base overcomes the frictional force such that the cordless electrical connector freely separates from the cordless electrical adaptor.

20. A liquid heating appliance comprising:
a liquid heating vessel comprising a cordless electrical adaptor; and
a cordless power base arranged to support the liquid heating vessel thereon, wherein the cordless power base comprises a cordless electrical connector arranged to mate with the cordless electrical adaptor when the liquid heating vessel is seated on the cordless power base; wherein:
at least one of the cordless electrical connector and the cordless electrical adaptor comprises at least one resiliently biased vertically acting member applying a vertical force acting to separate the cordless electrical connector and cordless electrical adaptor when the cordless electrical connector and cordless electrical adaptor are mated together;
at least one of the cordless electrical connector and the cordless electrical adaptor comprises at least one resiliently biased horizontally acting member applying a horizontal force to the other of the cordless electrical connector or the cordless electrical adaptor when the cordless electrical connector and cordless electrical adaptor are mated together, and wherein the horizontal force forms a frictional force acting between the cordless electrical connector and cordless electrical adaptor which acts to resist separation of the cordless electrical connector and the cordless electrical adaptor; and wherein:
the vertical force applied by the at least one resiliently biased vertically acting member and the horizontal force applied by the at least one resiliently biased horizontally acting member are pre-set such that the forces acting between the cordless power base and the liquid heating vessel are balanced so that when the liquid heating vessel is seated on the cordless power base the liquid heating vessel does not separate from the cordless power base and when the liquid heating vessel is lifted away from the cordless power base the cordless power base freely separates from the liquid heating vessel.
